(19) United States
(12) Patent Application Publication
(10) Pub. No.: US 2024/0095585 A1
(43) Pub. Date: Mar. 21, 2024

(54) Method And Apparatus For Generalization Of Artificial Intelligence/Machine Learning Model

(71) Applicant: MediaTek Inc., Hsinchu City (TW)

(72) Inventors: Gyu Bum Kyung, San Jose, CA (US); Per Johan Mikael Johansson, Kungsangen (SE)

(21) Appl. No.: 18/241,974

(22) Filed: Sep. 4, 2023

Related U.S. Application Data
(60) Provisional application No. 63/375,704, filed on Sep. 15, 2022.

(51) Int. Cl. G06N 20/00

(52) U.S. Cl. CPC G06N 20/00

(57) ABSTRACT

Techniques pertaining to generalization of an artificial intelligence (AI)/machine learning (ML) model in wireless communications are described. A user equipment (UE) receives, from a network, an indicator related to a network environment surrounding the UE. The UE utilizes the indicator as an additional input with respect to an AI/(ML model.

### CROSS REFERENCE TO RELATED PATENT APPLICATION(S)

The present disclosure is part of a non-provisional application claiming the priority benefit of U.S. Patent Application No. 63/375,704, filed 15 Sep. 2022, the content of which herein being incorporated by reference in its entirety.

### TECHNICAL FIELD

The present disclosure is generally related to wireless communications and, more particularly, to generalization of an artificial intelligence (AI) and machine learning (ML) model in wireless communications.

### BACKGROUND

Unless otherwise indicated herein, approaches described in this section are not prior art to the claims listed below and are not admitted as prior art by inclusion in this section.

In general, an AI/ML model performs well with a given training dataset. Yet, the AI/ML model may perform poorly with an unknown test dataset. This problem is known as an overfitting problem, and “overfitting” usually happens when the model is overly complex and almost perfectly matches with the training dataset only. When testing with new data sample(s) having quite different characteristics and/or distribution from the training dataset, an overfitted model cannot match with the new data sample(s). To overcome the overfitting problem, conventional approaches typically involve a regularization method, dropout, and so on. Another approach involves using an additional training set with more collected data after the model is already deployed in the field, and this approach is referred to as online training. Online training can help adjusting the model for more diverse channel environment in the context of wireless communications.

When designing an AI/ML model, it is necessary to consider the generalization of the AI/ML model in order to avoid the overfitting problem. However, it tends to be difficult to collect a comprehensive training dataset which sufficiently covers all different real-world characteristics and/or properties. Besides, even if such a comprehensive training dataset could be collected, it would not be easy to design a suitable AI/ML model. Therefore, there is a need for a solution of generalization of an AI/ML model, such as for application in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure pertain to generalization of an AI/ML model in wireless communications. It is believed that implementations of the various proposed schemes may address or otherwise alleviate the aforementioned issue(s).

In one aspect, a method may involve a user equipment (UE) receiving, from a network, an indicator related to a network environment surrounding the UE. The method may also involve the UE utilizing the indicator as an additional input with respect to an AI/ML model.

In another aspect, a method may involve a network node determining an indicator related to a network environment surrounding a UE. The method may also involve the network node transmitting the indicator to the UE which utilizes the indicator as an additional input with respect to an AI/ML model executed by the UE.

In yet another aspect, an apparatus may include a transceiver configured to communicate wirelessly and a processor coupled to the transceiver. The processor may receive, from a network, an indicator related to a network environment surrounding the UE. The processor may also utilize the indicator as an additional input with respect to an AI/ML model.

It is noteworthy that, although description provided herein may be in the context of certain radio access technologies, networks, and network topologies for wireless communication, such as 5^{th} Generation (5G)/New Radio (NR) mobile communications, the proposed concepts, schemes and any variation(s)/derivative(s) thereof may be implemented in, for and by other types of radio access technologies, networks and network topologies such as, for example and without limitation, Evolved Packet System (EPS), Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of example scenarios in accordance with an implementation of the present disclosure.

FIG. 2 is a diagram of an example scenario in accordance with an implementation of the present disclosure.

FIG. 3 is a block diagram of an example communication system in accordance with an implementation of the present disclosure.

FIG. 4 is a flowchart of an example process in accordance with an implementation of the present disclosure.

FIG. 5 is a flowchart of an example process in accordance with an implementation of the present disclosure.

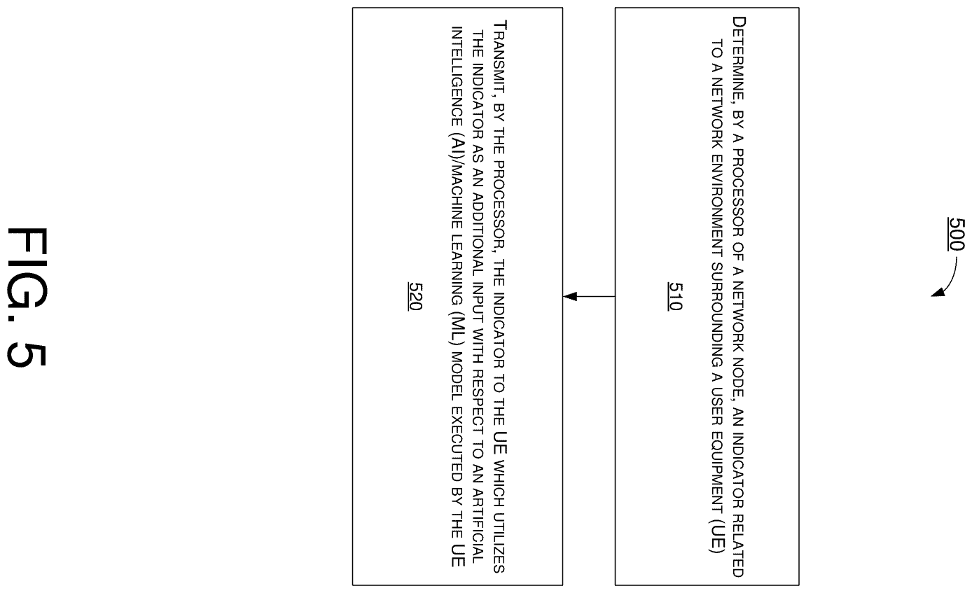

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that the description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to generalization of an AI/ML model in wireless communications. According to the present disclosure, a number of possible solutions may be implemented separately or jointly. That is, although these possible solutions may be described below separately, two or more of these possible solutions may be implemented in one combination or another.

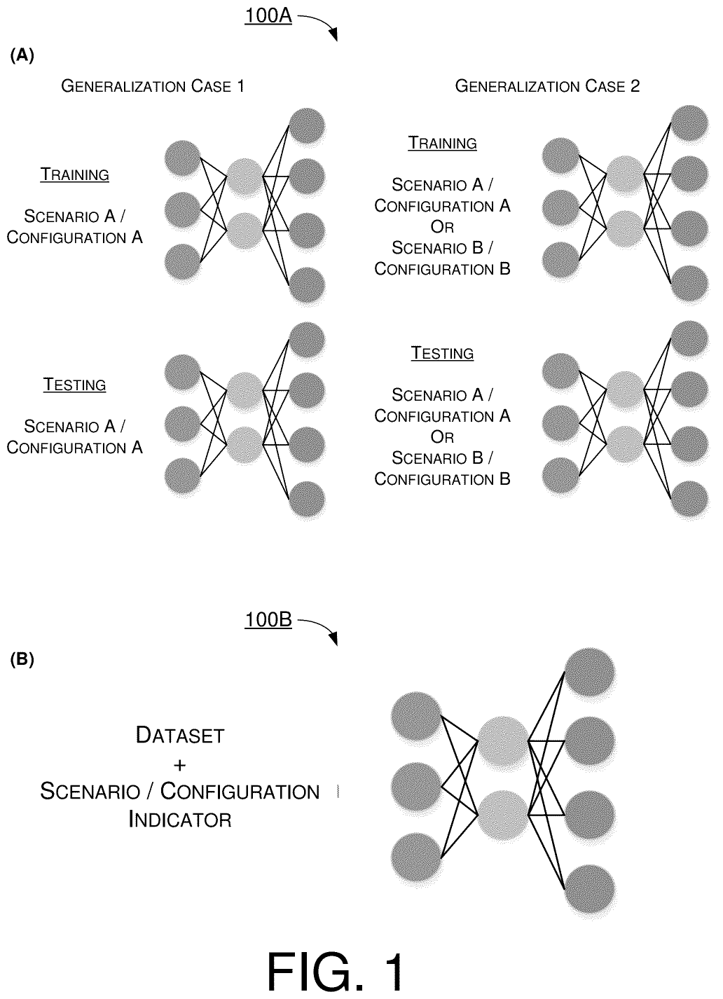

FIG. 1 illustrates example scenarios 100A and 100B in accordance with an implementation of the present disclosure. As shown in part (A) of FIG. 1, in generalization of an AI/ML model in scenario 100A, certain cases may be considered: (1) training with dataset(s) corresponding to scenario #A/configuration #A→testing with dataset(s) corresponding to scenario #B/configuration #B; and (2) training with dataset(s) corresponding to scenario #A/configuration #A and scenario #B/configuration #B→testing with dataset(s) corresponding to scenario #A/configuration #A or dataset(s) corresponding to scenario #B/configuration #B. However, with more and more datasets, it may be very difficult to collect a comprehensive training dataset which covers all different real-world characteristics and/or properties. Even with such a comprehensive dataset, it would be difficult to train the AI/ML model.

As shown in part (B) of FIG. 1, under a proposed scheme in accordance with the present disclosure, instead of letting the AI/ML model attempting to determine or otherwise figure out the scenario or configuration of a dataset, in scenario 100B an additional input (e.g., a Scenario/Configuration indicator) may be utilized to specify the scenario or configuration among a plurality of scenarios/configurations in the dataset (which is another input to the AI/ML model). This additional input of the Scenario/Configuration indicator may help the AI/ML model cover many different real-world characteristics and/or properties. Thus, the overfitting problem for certain scenario(s) and/or configuration(s) may be minimized or otherwise reduced. Without such an additional input/indication, a huge network may be required in order to extract important features from a mixed dataset.

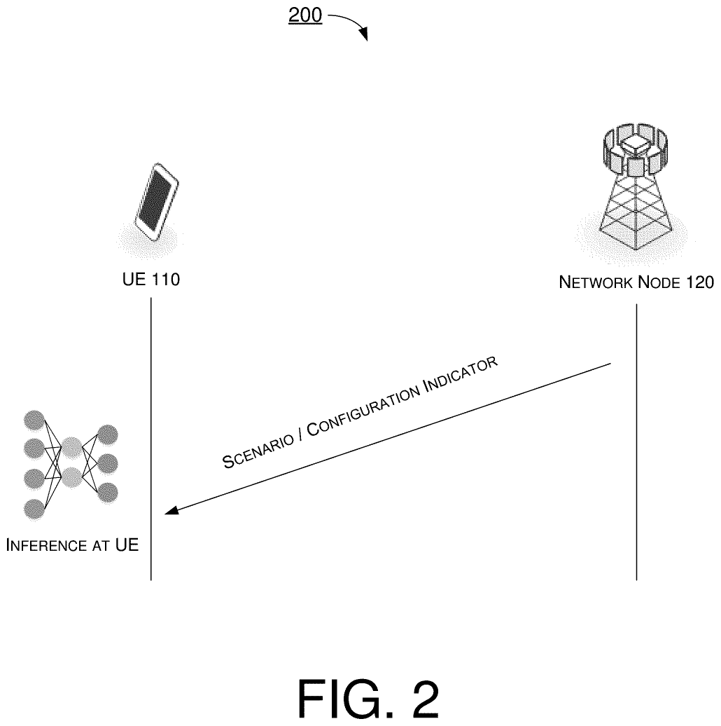

FIG. 2 illustrates an example scenario 200 in accordance with an implementation of the present disclosure. Scenario 200 may involve a UE 110 in wireless communication with a network node 120 of a wireless network (e.g., a 5G/NR network or another type of mobile network) under one or more specifications of the 3^{rd} Generation Partnership Project (3GPP). Network node 120 may be a terrestrial network node (e.g., base station, eNB, gNB or transmit-and-receive point (TRP)) or a non-terrestrial network node (e.g., satellite). The AI/ML model under various proposed schemes in accordance with the present disclosure may be implemented in a 3GPP system such as that involving UE 110 and network node 120, and the Scenario/Configuration indicator may be signaled by network node 120 to UE 110 via radio resource control (RRC) signaling (e.g., through RRC parameter(s)) or via another type of signaling (e.g., using medium access control (MAC) control element (CE) or downlink control information (DCI)). Since the network typically has better cell information regarding the channel condition (or channel state) and/or deployment environment (e.g., when UE 110 moves from one cell to another), the network may know the network environment and thus may signal the Scenario/Configuration indicator to UE 110 as an additional input to the AI/ML model implemented by/on UE 110, thereby assisting the training and performance of that AI/ML model at UE 110. That is, the network may map the Scenario/Configuration indicator to a current network environment surrounding UE 110 and then transmit the Scenario/Configuration indicator to UE 110.

For instance, the Scenario/Configuration indicator may indicate a specific scenario or configuration from which dataset(s) may be collected, and UE 110 may utilize the Scenario/Configuration indicator as an additional input for its AI/ML model in generalization of the AI/ML model. Moreover, the network may, via network node 120, transmit a RRC parameter via RRC signaling to UE 110, with the RRC parameter containing the Scenario/Configuration indicator. The Scenario/Configuration indicator may be used as an inference by UE 110, thereby assisting or aiding UE 110 in training the AI/ML model to perform with different mixed datasets. As an example, the scenario/configuration may be any of urban macro (UMA), urban micro (UMI), rural macro (RMA) scenarios, and an index of the Scenario/Configuration indicator may be an integer or a real number. Thus, the Scenario/Configuration indicator provided by network node 120 to UE 110 may be “UMA23”, “UMI25.5” or “RMA150” as a general indicator. As datasets of UMA, UMI and RMA may be shared with or known by UE 110 prior to deployment, the Scenario/Configuration indicator may be used as an inference (e.g., as a dataset tag) by UE 110 in addition to a dataset (e.g., data collected by sensor(s) of UE 110) as input to the AI/ML model executed by/on UE 110, thereby producing an optimal output. It is noteworthy that, in case that there are multiple AI/ML models at UE 110, the Scenario/Configuration indicator may be used by UE 110 in selecting one of the AI/ML models for training and/or simulation. In case that there is one AI/ML model at UE 110, the Scenario/Configuration indicator may be used by UE 110 in selecting parameter(s) from the dataset for the AI/ML model to perform training and/or simulation. Ultimately, the AI/ML model may be trained to enhance the performance of UE 110 in various applications such as, for example and without limitation, channel state information (CSI) prediction in time, beam management (BM), positioning, and so forth.

### Illustrative Implementations

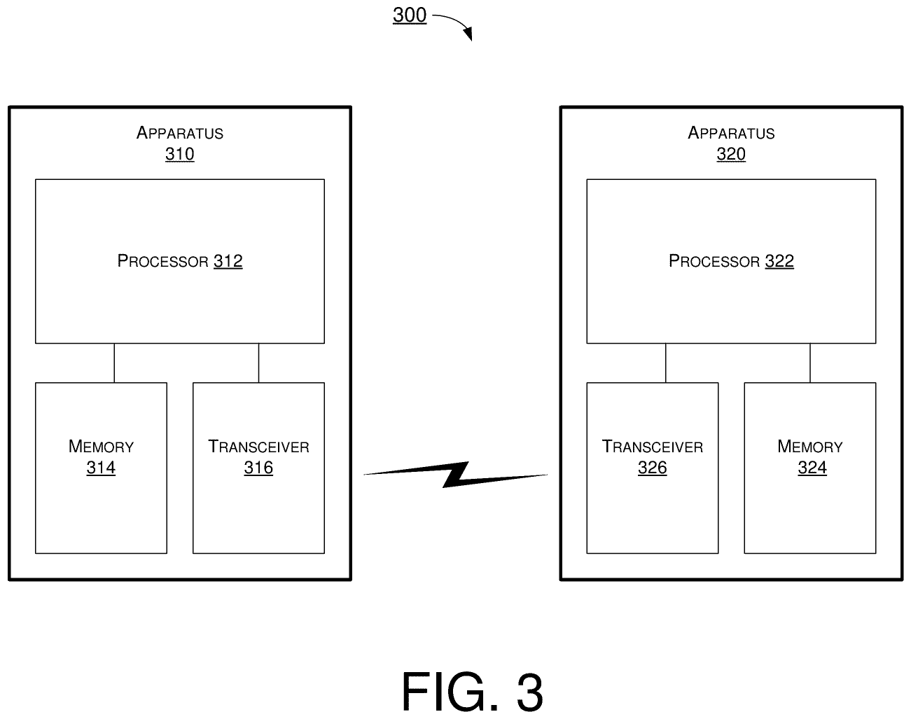

FIG. 3 illustrates an example communication system 300 having at least an example apparatus 310 and an example apparatus 320 in accordance with an implementation of the present disclosure. Each of apparatus 310 and apparatus 320 may perform various functions to implement schemes, techniques, processes and methods described herein pertaining to CSI compression and decompression, including the various schemes described above with respect to various proposed designs, concepts, schemes, systems and methods described above, including network environment 100, as well as processes described below.

Each of apparatus 310 and apparatus 320 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 310 and apparatus 320 may be implemented in a smartphone, a smartwatch, a personal digital assistant, an electronic control unit (ECU) in a vehicle, a digital camera, or a computing equipment such as a tablet computer, a laptop computer or a notebook computer. Each of apparatus 310 and apparatus 320 may also be a part of a machine type apparatus, which may be an IoT apparatus such as an immobile or a stationary apparatus, a home apparatus, a roadside unit (RSU), a wire communication apparatus, or a computing apparatus. For instance, each of apparatus 310 and apparatus 320 may be implemented in a smart thermostat, a smart fridge, a smart door lock, a wireless speaker or a home control center. When implemented in or as a network apparatus, apparatus 310 and/or apparatus 320 may be implemented in an eNodeB in an LTE, LTE-Advanced or LTE-Advanced Pro network or in a gNB or TRP in a 5G network, an NR network or an IoT network.

In some implementations, each of apparatus 310 and apparatus 320 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 310 and apparatus 320 may be implemented in or as a network apparatus or a UE. Each of apparatus 310 and apparatus 320 may include at least some of those components shown in FIG. 3 such as a processor 312 and a processor 322, respectively, for example. Each of apparatus 310 and apparatus 320 may further include one or more other components not pertinent to the proposed scheme of the present disclosure (e.g., internal power supply, display device and/or user interface device), and, thus, such component(s) of apparatus 310 and apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC or RISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including those pertaining to generalization of an AI/ML model in wireless communications in accordance with various implementations of the present disclosure.

In some implementations, apparatus 310 may also include a transceiver 316 coupled to processor 312. Transceiver 316 may be capable of wirelessly transmitting and receiving data. In some implementations, transceiver 316 may be capable of wirelessly communicating with different types of wireless networks of different radio access technologies (RATs). In some implementations, transceiver 316 may be equipped with a plurality of antenna ports (not shown) such as, for example, four antenna ports. That is, transceiver 316 may be equipped with multiple transmit antennas and multiple receive antennas for multiple-input multiple-output (MIMO) wireless communications. In some implementations, apparatus 320 may also include a transceiver 326 coupled to processor 322. Transceiver 326 may include a transceiver capable of wirelessly transmitting and receiving data. In some implementations, transceiver 326 may be capable of wirelessly communicating with different types of UEs/wireless networks of different RATs. In some implementations, transceiver 326 may be equipped with a plurality of antenna ports (not shown) such as, for example, four antenna ports. That is, transceiver 326 may be equipped with multiple transmit antennas and multiple receive antennas for MIMO wireless communications.

In some implementations, apparatus 310 may further include a memory 314 coupled to processor 312 and capable of being accessed by processor 312 and storing data therein. In some implementations, apparatus 320 may further include a memory 324 coupled to processor 422 and capable of being accessed by processor 322 and storing data therein. Each of memory 314 and memory 324 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 314 and memory 324 may include a type of read-only memory (ROM) such as mask ROM, programmable ROM (PROM), erasable programmable ROM (EPROM) and/or electrically erasable programmable ROM (EEPROM). Alternatively, or additionally, each of memory 314 and memory 324 may include a type of non-volatile random-access memory (NVRAM) such as flash memory, solid-state memory, ferroelectric RAM (FeRAM), magnetoresistive RAM (MRAM) and/or phase-change memory.

Each of apparatus 310 and apparatus 320 may be a communication entity capable of communicating with each other using various proposed schemes in accordance with the present disclosure. For illustrative purposes and without limitation, a description of capabilities of apparatus 310, as a UE (e.g., UE 110), and apparatus 320, as a network node (e.g., network node 125) of a network (e.g., network 130 as a 5G/NR mobile network), is provided below in the context of example processes 400 and 500.

### Illustrative Processes

Each of the processes 400 and 500 may represent an aspect of implementing various proposed designs, concepts, schemes, systems and methods described above pertaining to generalization of an AI/ML model in wireless communications, whether partially or entirely, including those pertaining to those described above. Each process may include one or more operations, actions, or functions as illustrated by one or more of blocks. Although illustrated as discrete blocks, various blocks of each process may be divided into additional blocks, combined into fewer blocks, or eliminated, depending on the desired implementation. Moreover, the blocks/sub-blocks of each process may be executed in the order shown in each figure, or, alternatively in a different order. Furthermore, one or more of the blocks/sub-blocks of each process may be executed iteratively. Each process may be implemented by or in apparatus 310 and/or apparatus 320 as well as any variations thereof. Solely for illustrative purposes and without limiting the scope, each process is described below in the context of apparatus 310 as a UE (e.g., UE 110) and apparatus 320 as a communication entity such as a network node or base station (e.g., terrestrial network node 120) of a network (e.g., a 5G/NR mobile network).

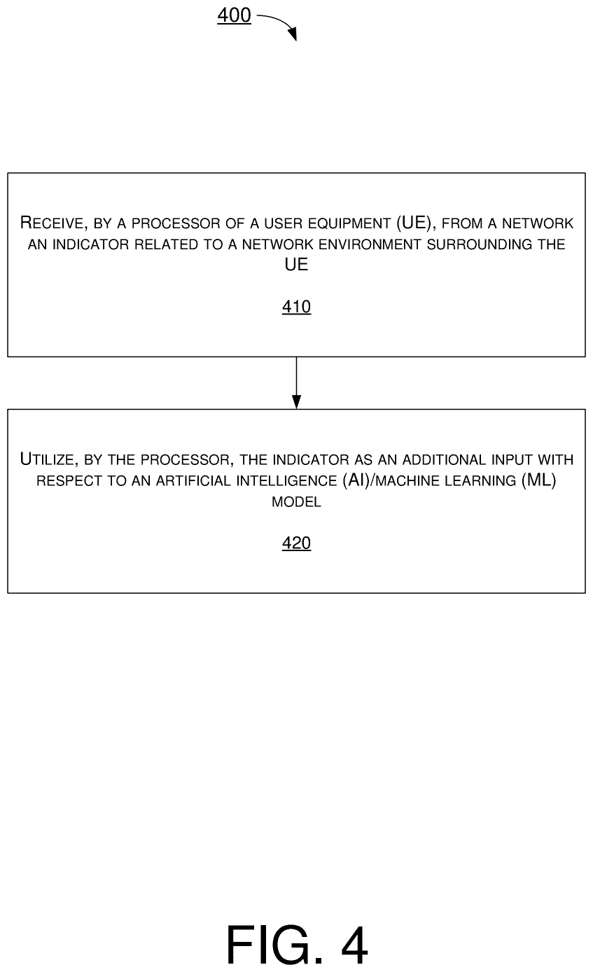

FIG. 4 illustrates an example process 400 in accordance with an implementation of the present disclosure. Process 400 may begin at block 410. At 410, process 400 may involve processor 312 of apparatus 310 (e.g., as UE 110) receiving, via transceiver 316, from a network (e.g., via apparatus 320 as network node 120) an indicator related to a network environment surrounding apparatus 310. Process 400 may proceed from 410 to 420.

At 420, process 400 may involve processor 312 utilizing the indicator as an additional input with respect to an AI/ML model.

In some implementations, in utilizing the indicator, process 400 may involve processor 312 selecting a parameter of a dataset, which is provided to the AI/ML model as an input, based on the indicator.

In some implementations, in utilizing the indicator, process 400 may involve processor 312 selecting the AI/ML model from multiple AI/ML models.

In some implementations, the indicator may be mapped to a scenario or configuration of the network environment.

In some implementations, the indicator may include an integer or a real number.

In some implementations, in receiving the indicator, process 400 may involve processor 312 receiving the indicator in a RRC parameter, via DCI signaling, or in a MAC CE.

FIG. 500 illustrates an example process 500 in accordance with an implementation of the present disclosure. Process 500 may begin at block 510. At 510, process 500 may involve processor 322 of apparatus 320 (e.g., as network node 120) determining an indicator related to a network environment surrounding apparatus 320 (e.g., as UE 110). Process 500 may proceed from 510 to 520.

At 520, process 500 may involve processor 322 transmitting, via transceiver 326, the indicator to apparatus 310 which utilizes the indicator as an additional input with respect to an AI/ML model executed by apparatus 310.

In some implementations, the indicator may be mapped to a scenario or configuration of the network environment.

In some implementations, the indicator may include an integer or a real number.

In some implementations, in transmitting the indicator, process 500 may involve processor 322 transmitting the indicator in a RRC parameter, via DCI signaling, or in a MAC CE.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of a user equipment (UE), from a network an indicator related to a network environment surrounding the UE; and
utilizing, by the processor, the indicator as an additional input with respect to an artificial intelligence (AI)/machine learning (ML) model.

2. The method of claim 1, wherein the utilizing of the indicator comprises selecting a parameter of a dataset, which is provided to the AI/ML model as an input, based on the indicator.

3. The method of claim 1, wherein the utilizing of the indicator comprises selecting the AI/ML model from multiple AI/ML models.

4. The method of claim 1, wherein the indicator is mapped to a scenario or configuration of the network environment.

5. The method of claim 1, wherein the indicator comprises an integer or a real number.

6. The method of claim 1, wherein the receiving of the indicator comprises receiving the indicator in a radio resource control (RRC) parameter.

7. The method of claim 1, wherein the receiving of the indicator comprises receiving the indicator via downlink control information (DCI) signaling.

8. The method of claim 1, wherein the receiving of the indicator comprises receiving the indicator in a medium access control (MAC) control element (CE).

9. A method, comprising:
determining, by a processor of a network node, an indicator related to a network environment surrounding a user equipment (UE); and
transmitting, by the processor, the indicator to the UE which utilizes the indicator as an additional input with respect to an artificial intelligence (AI)/machine learning (ML) model executed by the UE.

10. The method of claim 9, wherein the indicator is mapped to a scenario or configuration of the network environment.

11. The method of claim 9, wherein the indicator comprises an integer or a real number.

12. The method of claim 9, wherein the transmitting of the indicator comprises transmitting the indicator in a radio resource control (RRC) parameter.

13. The method of claim 9, wherein the transmitting of the indicator comprises transmitting the indicator via downlink control information (DCI) signaling.

14. The method of claim 9, wherein the transmitting of the indicator comprises transmitting the indicator in a medium access control (MAC) control element (CE).

15. An apparatus implementable in a user equipment (UE), comprising:
a transceiver configured to communicate wirelessly; and
a processor coupled to the transceiver and configured to perform operations comprising:
receiving, via the transceiver, from a network an indicator related to a network environment surrounding the UE; and
utilizing the indicator as an additional input with respect to an artificial intelligence (AI)/machine learning (ML) model.

16. The apparatus of claim 15, wherein the utilizing of the indicator comprises selecting a parameter of a dataset, which is provided to the AI/ML model as an input, based on the indicator.

17. The apparatus of claim 15, wherein the utilizing of the indicator comprises selecting the AI/ML model from multiple AI/ML models.

18. The apparatus of claim 15, wherein the indicator is mapped to a scenario or configuration of the network environment.

19. The apparatus of claim 15, wherein the indicator comprises an integer or a real number.

20. The apparatus of claim 15, wherein the receiving of the indicator comprises receiving the indicator in a radio resource control (RRC) parameter, via downlink control information (DCI) signaling, or in a medium access control (MAC) control element (CE).
